(19) United States
(12) Patent Application Publication
(10) Pub. No.: US 2017/0207675 A1
(43) Pub. Date: Jul. 20, 2017

(54) Coil For An Electric Machine

(71) Applicant: ZF FRIEDRICHSHAFEN AG, Friedrichshafen (DE)

(72) Inventors: Ralf RÖNNEBECK, Schweinfurt (DE); Christian BRÜCKNER, Rimpar (DE); Michael MEIER, Selb (DE)

(21) Appl. No.: 15/321,433

(22) PCT Filed: Jun. 1, 2015
(86) PCT No.: PCT/EP2015/062053

§ 371 Date: Dec. 22, 2016

(30) Foreign Application Priority Data
Jul. 4, 2014 (DE) 10 2014 213 025.5

(51) Int. Cl. H02K 3/52

(52) U.S. Cl. CPC H02K 3/522; H02K 2203/06

(57) ABSTRACT

A coil for a stator of an electric machine, comprising a winding body with a winding area formed by a winding carrier and two legs that limit the winding area connected to the winding carrier. At least one leg has a first wire guide area, a coil winding arranged at the winding body and which has a winding wire with a winding start area and a winding end area and with coil ends extending, respectively, from the winding start area and the winding end area. One coil end is arranged at the first wire guide area and exits from the coil at the first wire guide area. A coil end located between the winding start area or the winding end area and the first wire guide area is constructed with a free wire portion in which the winding wire is arranged in a cantilevering manner.

### CROSS REFERENCE TO RELATED APPLICATION

This is a U.S. national stage of application No. PCT/EP2015/062053, filed on Jun. 1, 2015. Priority is claimed on German Application No.: DE102014213025.5, Filed Jul. 4, 2014, the content of which is incorporated here by reference.

### BACKGROUND OF THE INVENTION

1. Field of the Invention

The present invention is directed to a coil for an electric machine.

2. Description of the Prior Art

A generic coil with winding bodies made of plastic is known from DE 198 50 818 A1. These winding bodies have a winding area for receiving a wire winding, and the winding area is formed in each instance by a winding carrier provided for contacting a stator lamination stack of an electric machine and two legs that limit the winding area and are connected to the winding carrier. The coil ends are connected to a plurality of shared ring conductors of a directly adjacent connection arrangement, for example in a delta connection or star connection, and mechanically fixed thereto, the coil ends being guided on the shortest possible path to their connection point.

In operation, an arrangement of this type is subject to vibrations occurring particularly in conjunction with an internal combustion engine in a vehicle powertrain. This can lead to relative movements and to a permanent alternating loading of the coil winding and connection arrangement. The ends of the coils are stressed in particular. As a result, an insulating sleeve of the winding wire may be damaged and a short circuit may be caused between the conductor elements which are at different potentials. In the worst case, wire may tear off in this area and can lead to limited output or to outage of the electric machine.

### SUMMARY OF THE INVENTION

Based on the above-mentioned prior art, it is an object of one aspect of the present invention to provide a coil of the type mentioned above which offers a higher resistance and greater reliability under the influence of vibrations.

First, the coil suggested herein, particularly a coil for a stator of an electric machine, comprises a winding body with a winding area formed by a winding carrier and two legs which limit the winding area and are connected to the winding carrier, and at least one leg that has a first wire guide area. The coil further comprises a coil winding arranged at the winding body and comprises a winding wire with a winding start area and a winding end area and with coil ends extending, respectively, from the winding start area and the winding end area, and one coil end is arranged at the first wire guide area and exits from the coil at the first wire guide area.

The winding start area and winding end area refers to that portion of the coil winding at which the winding wire enters a circumferential wound coil winding direction and exits from the coil winding direction, respectively, and in so doing undergoes a change in direction relative to the wire which is wound circumferentially as coil. In other words, the winding start area and the winding end area are the immediate beginning and immediate end, respectively, of the coil winding. These areas may possibly be mechanically fixed to the remaining winding in addition through the use of a self-bonding wire as winding wire by cementing.

The wire guide area refers to steps taken at a leg which substantially limit the freedom of movement of the winding wire or coil ends at a predetermined position of the leg and which guide the coil ends at least in one direction, with the possibility of a certain clearance freedom. Of course, there may also be a limiting of the freedom of movement in two, or in all three, independent spatial directions. The coil wire can pass the first wire guide area also without a change in direction, which, in conjunction with a certain clearance freedom, allows a virtually unimpeded passage to a coil connection arrangement to which the coil ends are or can be fixed.

According to one aspect of the invention, the coil is characterized particularly in that between the winding start area or the winding end area and the first wire guide area the coil end has a free wire portion in which the winding wire is arranged in a cantilevering manner. The basic idea allows the coil ends formed at the coil to move freely, particularly to vibrate freely, instead of fastening them to the coil itself along their entire length as disclosed in the prior art. For example, a deformation of the wire compelled by torsion of structural component parts occurring as a result of operational vibrations is injected into a comparatively larger longitudinal portion resulting in less deformation per length unit. A plastic deformation of the winding wire which has occurred repeatedly heretofore and which finally results in brittle fracture can be prevented to a great extent in that the winding wire is stressed at least predominantly mechanically in its elastic deformation range, and damage mechanisms leading to breakage are accordingly subjugated.

A coil end can be installed on a direct, i.e., approximately shortest, path between the winding start area and/or the winding end area and the first wire guide area accompanied by a certain freedom of vibration. In a further development, the free wire portion can advantageously have a length greater than the distance between the winding start area or winding end area and the first wire guide area. In this way, the active external forces per length unit can be further dissipated, and a natural vibration frequency of the free wire portion also decreases. Accordingly, a greater length of the coil ends brings about an improved movement compensation relative to mechanical interfering influences.

In a further advantageous manner, the winding body can have a second wire guide area at the leg opposite the first wire guide area, the winding start area and/or the winding end area being arranged at this second wire guide area. This second wire guide area serves on the one hand for redirecting wire from the wire winding direction in direction of the opposite leg and, on the other hand, brings about a tension relief of the winding wire at the winding start area and winding end area. Structurally, a pin, a projection, a deflection groove, or the like can be formed at the leg for this purpose. The free wire portion accordingly extends between the first wire guide area and the second wire guide area.

Within the scope of the solution proposed herein, the free wire portion can have an approximately U-shaped indentation formed, for example, approximately in a winding plane of the coil winding or perpendicular to the winding plane. By forming an indentation of this kind, a substantial lengthening of the free wire portion is made possible in a simple manner This step can be applied particularly in a coil in which the winding start area and/or the winding end area are/is formed spatially adjoining the leg with the first wire guide area through which the winding wire exits the coil.

According to a configuration serving as alternative to or in addition to that described above, the free wire portion can also be formed at least partially helically to allow a dissipation of an externally injected vibration energy. A construction of this kind can be applied particularly, but not exclusively, in coils in which the winding start area and/or the winding end area are/is formed at a spatial distance from the leg with the first wire guide area through which the winding wire exits the coil, and the winding wire is guided at the other leg by a second wire guide area.

### BRIEF DESCRIPTION OF THE DRAWINGS

The invention will be described by way of example in the following with reference to an embodiment form shown in the drawings. In the drawings:

FIGS. 1a, b are two different views of single tooth coils for a stator of an electric machine with two coil ends which are fixed to a leg of a winding body accompanied by formation of a free wire portion; and

FIGS. 2a-d are different views of single tooth coils for a stator of an electric machine with two coil ends which are fixed to two legs of a winding body accompanied by formation of a free wire portion.

### DETAILED DESCRIPTION OF THE PRESENTLY PREFERRED EMBODIMENTS

Like objects, functional units or comparable components are denoted by identical reference numerals throughout the different drawings. Further, collective reference numerals may be used for components and objects which occur more than once in an embodiment example or diagram but which are described collectively with respect to one or more features. Components or objects which are denoted by identical reference numerals or collective reference numerals may be constructed identically or possibly also differently with respect to one or more or all features, for example, their dimensions, unless otherwise explicit or implicit from the description.

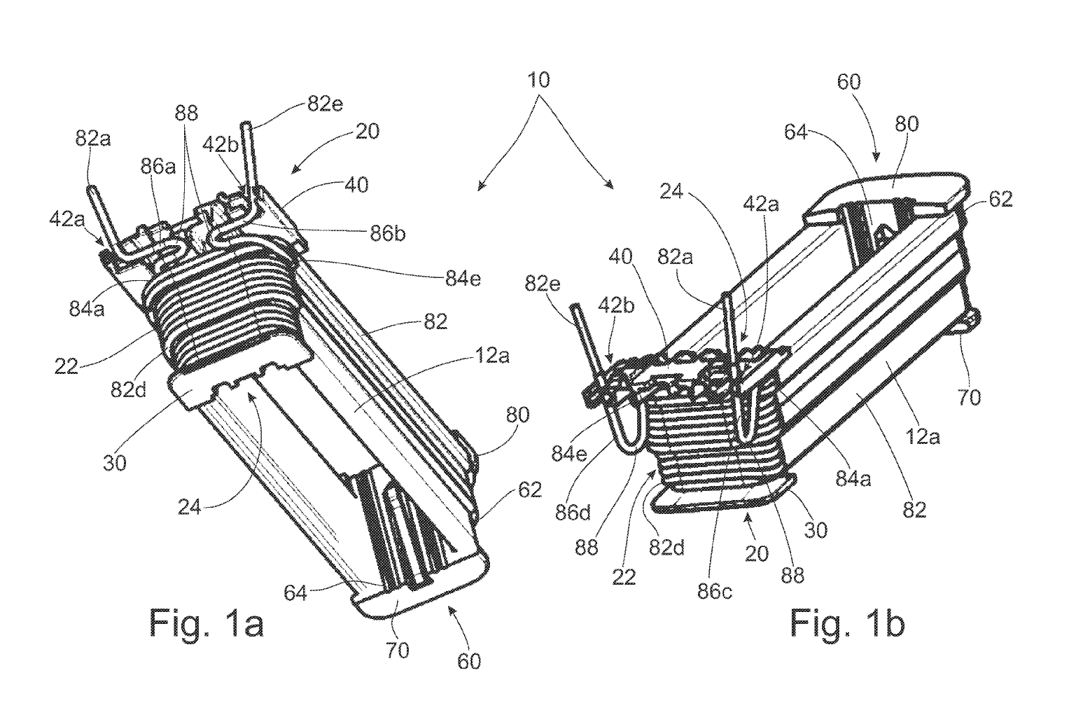

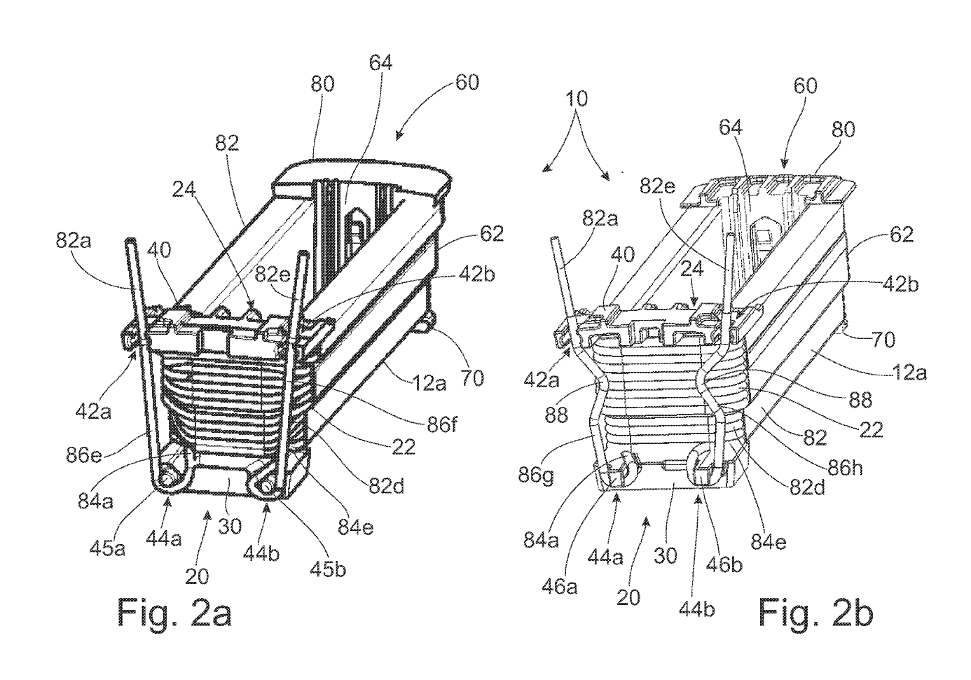

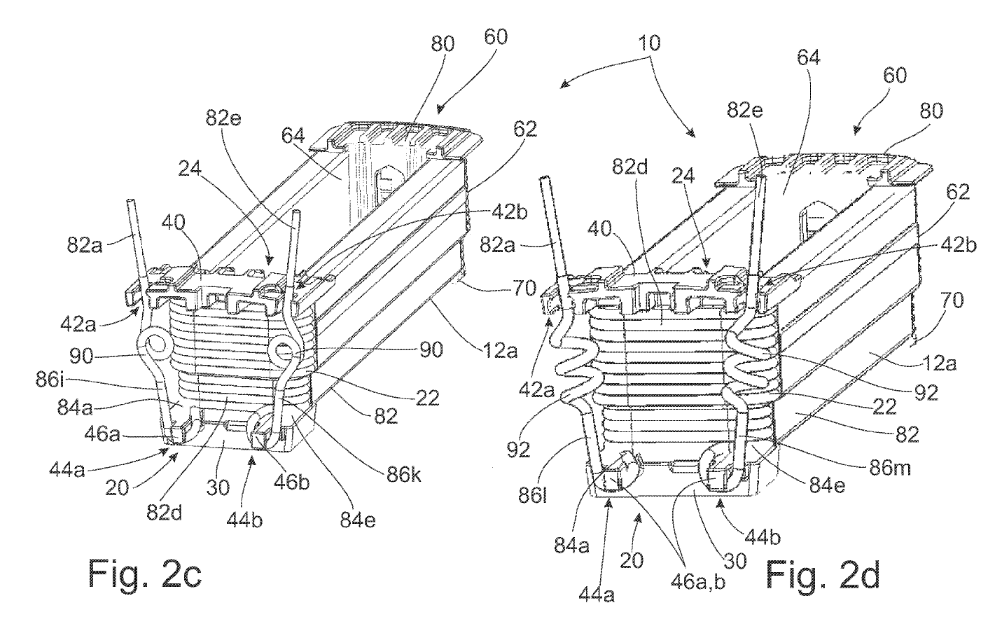

FIGS. 1a, b and FIGS. 2a-d show a coil 10, particularly for arranging at teeth of a stator, not shown, of an electric machine, for example, for a stator of a permanently excited synchronous machine.

Coil 10 comprises two winding bodies 20, 60 made of plastic arranged on the front of a stator tooth as end caps and which have a respective winding area 22, 62, respectively. The winding areas 22, 62 is formed by a winding carriers 24, 64 intended to contact a stator tooth and two legs 30, 40; 70, 80 which define the winding area 22, 62 and are connected to the winding carrier 24, 64. To this extent, winding body 20 corresponds to a known winding body. A further winding area 12a is formed at both sides between the winding bodies 20, 60 and extends along a stator tooth in the fitted state of coil 10 to stator.

A wire winding 82 or coil winding 82 comprising a flexible and relatively dimensionally stable winding wire 82d, particularly a copper enameled wire, is arranged at the winding bodies 20, 60. The wire winding 82 accordingly occupies the space formed by the winding areas 12a, 22 and 62. It will be seen that the coil 10 has two free coil ends 82a, 82e or winding ends 82a, 82e, both of which are fixed or guided at the winding body 20 and, beyond this, also jointly at the leg 40. Considered proceeding outward at the coil 10, the coil ends 82a, 82e pass into a winding start area 84a and a winding end area 84e.

By winding start area 84a and winding end area 84e is meant that portion of the coil winding 82 at which the winding wire 82d enters a circumferential wound coil winding direction and exits from the coil winding direction, respectively, and in so doing undergoes a change in direction relative to the wire 82d which is wound circumferentially as coil 10. In other words, the winding start area 84a and the winding end area 84e are the immediate beginning and immediate end, respectively, of the coil winding 82.

First wire guiding areas are formed in a groove-shaped or slot-shaped manner in this instance are provided at the leg 40 for guiding the coil ends 82a, e, the winding wire 82d being inserted therein and guided with a certain clearance at three sides, and the coil wire 82d can pass through in direction of a coil connection arrangement, not shown, virtually unimpeded without a change in direction.

A wire entry area is designated by reference numeral 42a and a wire exit area is designated by reference numeral 42b. The fixing or guiding of the winding ends 82a, 82e serves on the one hand to maintain the shape of the wire winding 82; on the other hand, the free coil ends or winding ends 82a, 82e are to be spatially oriented in a predetermined manner in this way so as to be ready for connecting, for example, by welding, soldering, crimping or the like method, to a location outside of the coil 10.

All of the coils 10 shown in FIGS. 1a, b and FIGS. 2a-d have in common that the coil ends 82a, 82e have a free wire portion 86a-m between the winding start area 84a and winding end area 84e, respectively, and the first wire guide area, i.e., the wire entry area 42a and the wire exit area 42b, the winding wire 82d being arranged in a cantilevering manner in this free wire portion 86a-m. Through these free wire portions 86, the coil ends 82a, 82e can move freely under the influence of external vibrations and can accordingly nondestructively dissipate energy introduced therein.

In all of the embodiment examples shown in the drawings, the free wire portion 86 further has a length that is greater than the distance between winding start area 84a and winding end area 84e, respectively, and first wire guide area 42. In FIGS. 1a and 1b, the free wire portions 86a-d additionally have in each instance a U-shaped indentation 88 formed approximately in the winding plane of the coil winding 82 in FIG. 1a and perpendicular to the winding plane in FIG. 1b. By winding plane is understood the plane defined by a wrap of winding wire 82d at the coil winding 82. In the coils 10 shown in FIGS. 1a, b, the winding start area 84a and the winding end area 84b are formed spatially adjacent to the leg 40 with the first wire guide area 42 through which the winding wire 82d exits the coil 10.

In the embodiment examples shown in FIGS. 2a-d, the winding body 20 has a second wire guide area; 44a, b at the leg 30 opposite the first wire guide area 42, the winding start area 84a and the winding end area 84e being arranged at this second wire guide area; 44a, b. This second wire guide area serves on the one hand for redirecting wire from the wire winding direction in direction of the opposite leg 40 and, on the other hand, brings about a tension relief of the winding wire 82d at the winding start area 84a and winding end area 84e. To this end, the second wire guide area comprises, in FIG. 2a, two pins 45a, b protruding from leg 30 and, in FIGS. 2b-d, two hooks 46a, b protruding from leg 30. Accordingly, the free wire portions 86e-m extend, respectively, between the first wire guide area 42 and the second wire guide area.

While the free wire portions 86e, f in FIG. 2a extend along the shortest path between the wire guide areas, the free wire portions 86g, h in FIG. 2b have an indentation 88, particularly an expanded U-shaped indentation, which is formed approximately perpendicular to the winding plane of the coil winding 82 in the present instance.

In the coils 10 shown in FIGS. 2c and 2d, the free wire portions 86i, k; 86l, m have helical areas 90, 92 with different orientations at the winding body 20 to make it possible to dissipate externally injected vibrations. In FIG. 2c, areas 90 have a single helix and are formed with a helix plane arranged perpendicular to the winding plane of coil 10. Areas 92 in FIG. 2d have multiple helices, and their helix plane coincides approximately with the winding plane of coil 10. In this context, helix plane means a central plane given by one wrap of the winding wire 82d.

1-5. (canceled)

6. A coil for a stator of an electric machine, comprising:
a winding body having:
a winding area formed by a winding carrier; and
two legs connected to the winding carrier that limit the winding area; and
at least one leg having a first wire guide area, and a coil winding arranged at the winding body; and
a winding wire having a winding start area, a winding end area, and coil ends extending, respectively, from the winding start area and the winding end area,
wherein one coil end is arranged at the first wire guide area and exits from the coil at the first wire guide area,
wherein at least one of the coil ends has free wire portion in which the winding wire is arranged in a cantilevering manner between the first wire guide area and one of the winding start area and the winding end area.

7. The coil according to claim 6, wherein the free wire portion has a length that is greater than a distance between the first wire guide area and one of the winding start area and winding end area.

8. The coil according to claim 6,
wherein the winding body has a second wire guide area at a one of the two legs opposite the first wire guide area, the winding start area and/or the winding end area being arranged at this second wire guide area, and
wherein the free wire portion extends between the first wire guide area and the second wire guide area.

9. The coil according to claim 7, wherein the free wire portion has a U-shaped indentation.

10. The coil according to claim 7, wherein the free wire portion has helical areas.

11. The coil according to claim 7,
wherein the winding body has a second wire guide area at a one of the two legs opposite the first wire guide area, the winding start area and/or the winding end area being arranged at this second wire guide area, and
wherein the free wire portion extends between the first wire guide area and the second wire guide area.
